(19) United States
(12) Patent Application Publication
(10) Pub. No.: US 2013/0183492 A1
(43) Pub. Date: Jul. 18, 2013

(54) METAL NANOPARTICLES ON SUBSTRATE AND METHOD OF FORMING THE SAME

(71) Applicant: SNU R&DB FOUNDATION, Seoul (KR)

(72) Inventors: Jung Joong LEE, Seoul (KR); Soon Ho KWON, Seoul (KR)

(73) Assignee: SNU R&DB FOUNDATION, Seoul (KR)

(21) Appl. No.: 13/743,425

(22) Filed: Jan. 17, 2013

(30) Foreign Application Priority Data
Jan. 17, 2012 (KR) 10-2012-0005404
Apr. 19, 2012 (KR) 10-2012-0040708

(51) Int. Cl. B05D 3/06; C25D 5/48

(52) U.S. Cl. CPC B05D 3/068; C25D 5/48
USPC 428/148; 427/535; 205/112

(57) ABSTRACT

Provided are metal nanoparticles formed by using a low-temperature process, uniformly distributed on a substrate, and having a uniform and accurate size, and a method of forming the same. A method of forming metal nanoparticles on a substrate includes preparing a substrate including a polymer; forming a metal containing layer on the substrate; and forming nanoparticles of the metal from the metal containing layer by processing the metal containing layer with inductively coupled plasma.

### TECHNICAL FIELD

The present invention relates to metal nanoparticles and a method of forming the same, and more particularly, to metal nanoparticles on a substrate and a method of forming the same.

### BACKGROUND ART

In general, metal nanoparticles refer to ultrafine particles having a size from several ten to several hundred nm. Since their specific surface area is very large, surface characteristics of the metal nanoparticles greatly influence solid-state properties. It is expected that new materials using metal nanoparticles may achieve effects such as a microdevice, a high-density thin film, functionally improved memory, high activation due to an increase in specific surface area, and improved durability due to energy distribution.

A representative method of forming metal nanoparticles is a coprecipitation method that is one of liquid phase methods. The coprecipitation method refers to a method of simultaneously precipitating various different ions in an aqueous solution or a non-aqueous solution. In this case, a very small amount of insoluble salt that is mixed and distributed in the solution may be precipitated together. In addition to the coprecipitation method, metal nanoparticles may also be formed by using chemical reaction of a copolymer or by processing a thin film with heat or a laser.

### DETAILED DESCRIPTION OF THE INVENTION

### Technical Problem

However, in the coprecipitation method, uniform and small nanoparticles may not be easily obtained such that a process that requires accurate size adjustment may not be allowed, and the nanoparticles may not be easily aligned on a substrate.

In the method of forming metal nanoparticles by using chemical reaction of a copolymer, although metal nanoparticles having relatively uniform size and distance may be aligned on a substrate, other chemical components may remain in the metal nanoparticles such that pure metal nanoparticles may not be easily obtained, a bonding force to a substrate may not be good, and large particles having a size equal to or greater than 50 nm may not be easily formed. Also, in the method of forming metal nanoparticles by processing a thin film with heat or a laser, due to a high-temperature process, the temperature of a substrate may be greatly increased.

The present invention provides metal nanoparticles formed by using a low-temperature process, uniformly distributed on a substrate, and having a uniform size and an accurate distance, and a method of forming the same. However, the scope of the present invention is not limited thereto.

### Technical Solution

According to an aspect of the present invention, there is provided a method of forming metal nanoparticles on a substrate, including preparing a substrate including a polymer; forming a metal containing layer on the substrate; and forming nanoparticles of the metal from the metal containing layer by processing the metal containing layer with inductively coupled plasma.

The substrate may include a polymer. Furthermore, the polymer may include polystyrene, polycarbonate, or polyimide.

The metal may include copper (Cu), nickel (Ni), silver (Ag), or gold (Au).

The metal containing layer may be formed by using physical vapor deposition (PVD), chemical vapor deposition (CVD), or electrodeposition.

The inductively coupled plasma may be formed by using a discharge gas including at least one selected from the group consisting of argon (Ar), hydrogen (H), and helium (He).

The inductively coupled plasma may be formed at a temperature equal to or less than 300° C.

The forming of the nanoparticles of the metal may include forming nanoparticles having a radius of 10 to 100 nm.

The forming of the nanoparticles of the metal may include adjusting a distance between and a size of the nanoparticles of the metal by processing the metal containing layer with the inductively coupled plasma by applying a bias voltage to the substrate.

The forming of the nanoparticles of the metal may include adjusting a distance between and a size of the nanoparticles of the metal by adjusting a process condition of the inductively coupled plasma applied to the substrate. Furthermore, the process condition of the inductively coupled plasma may include power and/or a process time of the inductively coupled plasma.

According to another aspect of the present invention, there is provided a method of forming metal nanoparticles on a substrate, including preparing a substrate including a polymer; forming a metal containing layer on the substrate; and forming nanoparticles of the metal by performing a dewetting process by processing the metal containing layer with inductively coupled plasma.

According to another aspect of the present invention, there are provided metal nanoparticles on a substrate, including a substrate including a polymer; and nanoparticles of metal directly contacting and distributed on the substrate. The metal may include copper (Cu), nickel (Ni), silver (Ag), or gold (Au).

According to another aspect of the present invention, there is provided a method of forming metal nanoparticles on a substrate, including preparing a substrate; forming a metal containing layer on the substrate; and forming nanoparticles of the metal from the metal containing layer by processing the metal containing layer with inductively coupled plasma by applying a bias voltage.

The substrate may include silicon (Si) or Si oxide.

The metal may include metal having a melting point equal to or less than 1800□.

The metal may include titanium (Ti), platinum (Pt), cobalt (Co), iron (Fe), copper (Cu), tin (Sn), nickel (Ni), gold (Au), or silver (Ag).

The metal containing layer may be formed by using physical vapor deposition (PVD), chemical vapor deposition (CVD), or electrodeposition.

The inductively coupled plasma may be formed by using a discharge gas including at least one selected from the group consisting of argon (Ar), hydrogen (H), and helium (He).

The inductively coupled plasma may be formed at a temperature equal to or less than 300° C.

The forming of the nanoparticles of the metal may include forming nanoparticles having a radius of 10 to 100 nm.

The forming of the nanoparticles of the metal may include adjusting a distance between and a size of the nanoparticles of the metal by adjusting a process condition of the inductively coupled plasma applied to the substrate. Furthermore, the process condition of the inductively coupled plasma may include power and/or a process time of the inductively coupled plasma.

The process condition of the inductively coupled plasma may include a bias voltage.

The method may further include oxidizing or nitrifying the formed nanoparticles of the metal.

### Advantageous Effects

According to an embodiment of the present invention, metal nanoparticles formed by using a low-temperature process, uniformly distributed on a substrate, and having a uniform and accurate size, and a method of forming the same may be achieved. The scope of the present invention is not limited to the above effect.

### DESCRIPTION OF THE DRAWINGS

FIG. 1 is a flowchart of a method of forming metal nanoparticles on a substrate, according to an embodiment of the present invention.

FIGS. 2A through 2C are cross-sectional views for describing the method illustrated in FIG. 1.

FIGS. 3A through 3F are scanning electron microscope (SEM) images of the surface of a copper (Cu) thin film formed on a substrate to a thickness of 4 nm and processed with inductively coupled plasma, as time passes.

FIGS. 4A through 4E are SEM images of the surfaces of Cu thin films formed on a substrate to various thicknesses and processed with inductively coupled plasma.

FIG. 4F is a graph showing correlations between a thickness of a Cu thin film and a diameter of Cu nanoparticles.

FIGS. 5A through 5D are SEM images of Cu nanoparticles formed on a polyimide substrate, according to an embodiment of the present invention.

FIGS. 6A and 6B are SEM images of Cu nanoparticles formed on a silicon (Si)/Si oxide substrate, according to an embodiment of the present invention.

FIG. 7 is an SEM image of Cu nanoparticles formed on a polystyrene substrate, according to an embodiment of the present invention.

### MODE OF THE INVENTION

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the sizes of elements are exaggerated for convenience of explanation.

Spatially relative terms, such as “above,” “upper,” “beneath,” “below,” “lower,” and the like, may be used herein for ease of description to describe one element's relationship to another element(s) as illustrated in the drawings. It will be understood that the spatially relative terms are intended to encompass different orientations of a device in use or operation in addition to the orientation depicted in the figures. For example, if a device in the drawing is turned over, elements described as “below” or “beneath” other elements would then be oriented “above” the other elements. Thus, the exemplary term “above” may encompass both an orientation of above and below.

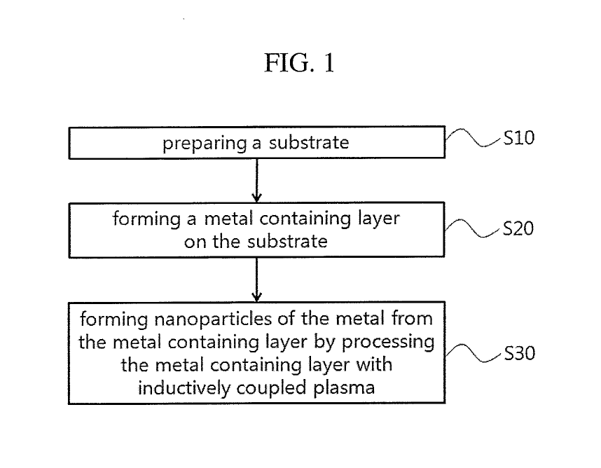

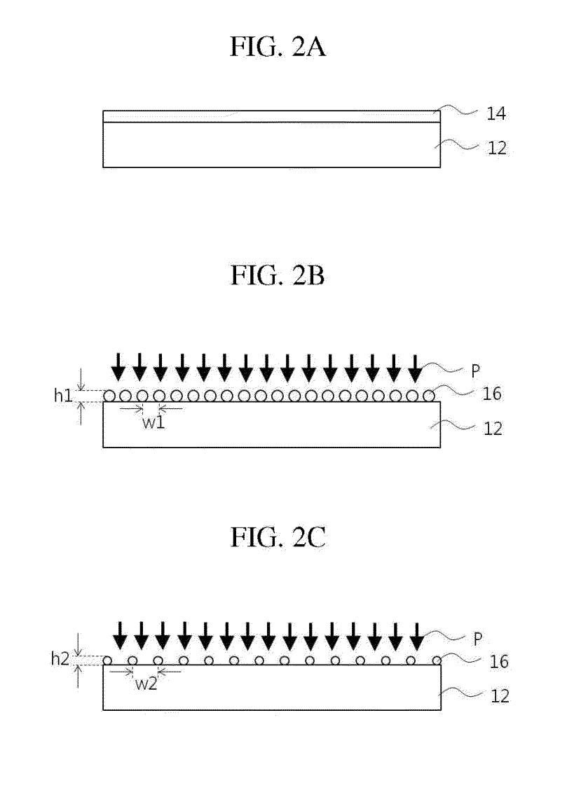

FIG. 1 is a flowchart of a method of forming metal nanoparticles on a substrate, according to an embodiment of the present invention. FIGS. 2A through 2C are cross-sectional views for describing the method illustrated in FIG. 1.

Referring to FIGS. 1, and 2A through 2C, the method according to the current embodiment includes preparing a substrate 12 (S10), forming a metal containing layer 14 on the substrate 12 (S20), and forming nanoparticles 16 of the metal from the metal containing layer 14 by processing the metal containing layer 14 with inductively coupled plasma P (S30).

The substrate 12 may include silicon (Si), Si oxide, or a polymer. The polymer may include, for example, polycarbonate or polyimide. A polymer is flexible and is injectable into a body so as to be used in bio industries, but is vulnerable to high temperature and thus requires a low-temperature process as a post process. Since the process to be described below according to the present invention corresponds to a low-temperature process, the nanoparticles 16 of the metal may be formed on the substrate 12 including a polymer.

The metal containing layer 14 is formed on the substrate 12. The metal containing layer 14 may be formed by using physical vapor deposition (PVD), chemical vapor deposition (CVD), or electrodeposition. Before the metal containing layer 14 is formed, a process of cleaning the substrate 12 may be optionally performed.

If the substrate 12 includes a polymer, the metal containing layer 14 may include metal such as copper (Cu), tin (Sn), nickel (Ni), gold (Au), or silver (Ag). Otherwise, if the substrate 12 include Si and/or Si oxide, the metal containing layer 14 may include metal having a melting point equal to or less than 1800□, for example, metal having a low melting point, e.g., Sn (melting point: about 232□), or metal having a high melting point, e.g., titanium (Ti) (melting point: about 1680□) or platinum (Pt) (melting point: about 1768□). In more detail, the metal containing layer 14 may include metal such as Ti, Pt, cobalt (Co), iron (Fe), Cu, Sn, Ni, Au, or Ag.

After that, by processing the metal containing layer 14 with the inductively coupled plasma P, the nanoparticles 16 of the metal may be formed from the metal containing layer 14. The inductively coupled plasma P is high-density plasma by using a phenomenon that a coil is wound around a reactor of a dielectric material such as quartz so as to change an electric field, an induced magnetic field is formed inside the coil, and thus a secondary induced current is formed in the reactor. The inductively coupled plasma P may be formed at a pressure from several to several ten mT by using a discharge gas including at least one selected from the group consisting of argon (Ar), hydrogen (H), and helium (He), and corresponds to a low-temperature process performed at a temperature equal to or less than 300□. In particular, if the substrate 12 includes a polymer that is vulnerable to high temperature, a low-temperature process performed at a temperature equal to or less than 300□ is very appropriate.

The nanoparticles 16 of the metal may have a radius of 10 to 100 nm, and a distance w1 or w2 between and a size h1 or h2 of the nanoparticles 16 of the metal may be adjusted by applying an appropriate bias voltage to the substrate 12 during the inductively coupled plasma P is formed. Furthermore, the distance w1 or w2 between and the size h1 or h2 of the nanoparticles 16 of the metal may be efficiently controlled by using a sputtering effect of the inductively coupled plasma P.

A process that the metal containing layer 14 is formed into the nanoparticles 16 of the metal includes a process of rupturing a thin film to form the nanoparticles 16 of the metal by allowing molecules of the metal containing layer 14 to move in a direction for reducing a surface energy. The above-described process of rupturing a thin film is referred to as dewetting. A conventional dewetting process has advantages such as an excellent processability, diversity in size of metal nanoparticles, and diversity in metal selected to form the metal nanoparticles, but also has disadvantages such as a relatively low uniformity due to a high-temperature process. However, the method according to the present invention includes a dewetting process including inductively coupled plasma processing, and thus has a great advantage as a low-temperature process.

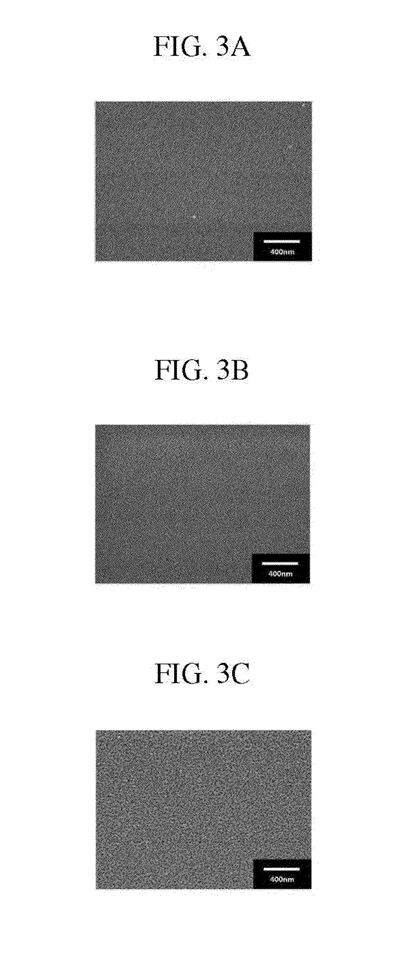

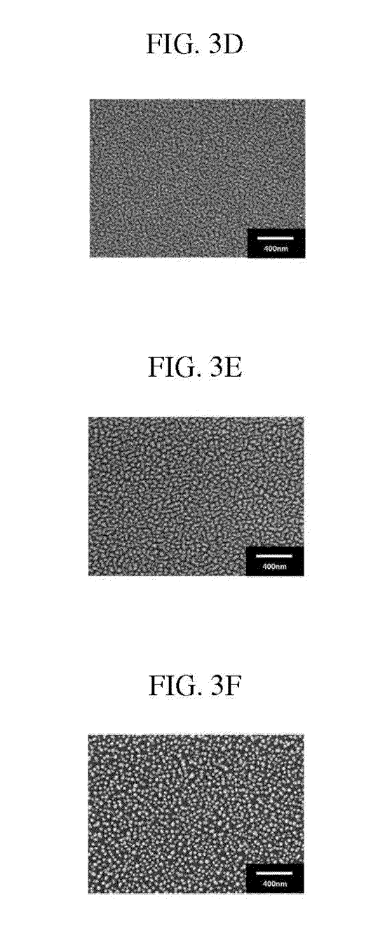

FIGS. 3A through 3F are scanning electron microscope (SEM) images of the surface of a Cu thin film formed on a substrate to a thickness of 4 nm and processed with inductively coupled plasma, as time passes. The inductively coupled plasma is formed by using a discharge gas including Ar.

FIG. 3A show a state when the Cu thin film is deposited, and FIGS. 3B through 3F respectively show states when inductively coupled plasma processing is performed for 1 min., 1.5 min., 2 min., 2.5 min., and 10 min. In an initial state, holes are formed over the whole Cu thin film, and may be mainly formed at particle boundaries having high energy levels in the Cu thin film. Furthermore, due to the inductively coupled plasma processing, holes having a more uniform distribution may be formed. The formation of holes causes formation of nanoparticles of Cu (bright parts in FIG. 3). It is shown that a distance between and a size of Cu nanoparticles are changed according to a process time of inductively coupled plasma.

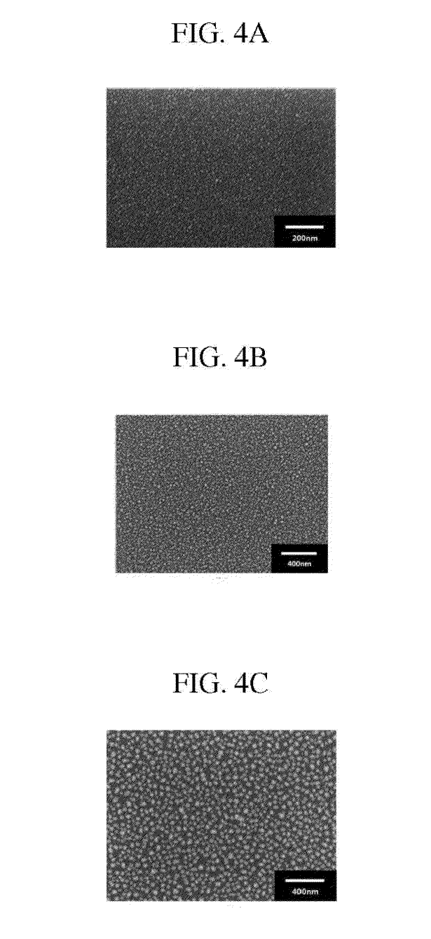

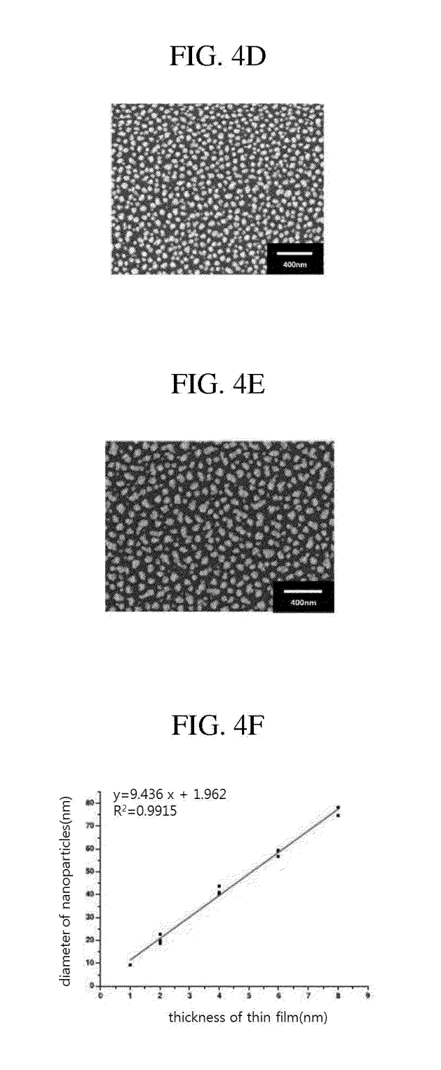

FIGS. 4A through 4E are SEM images of the surfaces of Cu thin films formed on a substrate to various thicknesses and processed with inductively coupled plasma. In more detail, FIGS. 4A through 4E are SEM images of the surfaces of Cu thin films respectively formed on a substrate to thicknesses of 1 nm, 2 nm, 4 nm, 6 nm, and 8 nm and processed with inductively coupled plasma. FIG. 4F is a graph showing correlations between a thickness of a Cu thin film and a diameter of Cu nanoparticles.

Here, the inductively coupled plasma is formed by using a discharge gas including Ar, and the Cu thin films are processed with the inductively coupled plasma for 1 hour. It is shown that, if the thickness of a Cu thin film deposited on a substrate is increased, the diameter of Cu nanoparticles formed on the substrate is also increased.

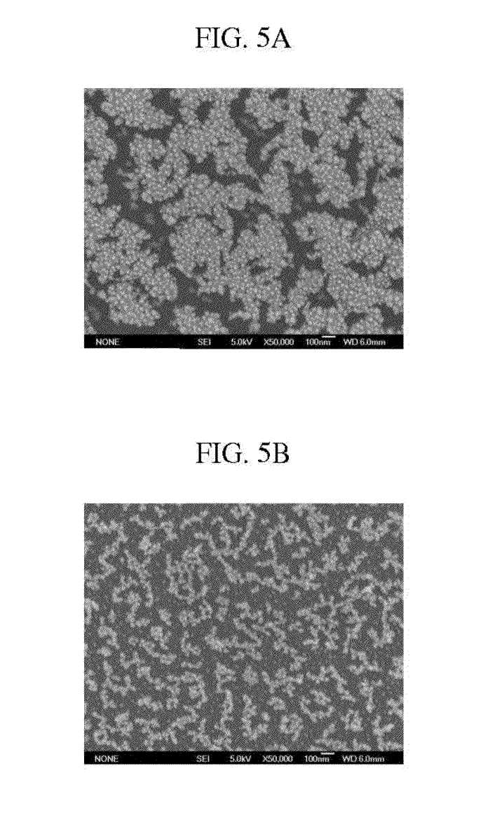

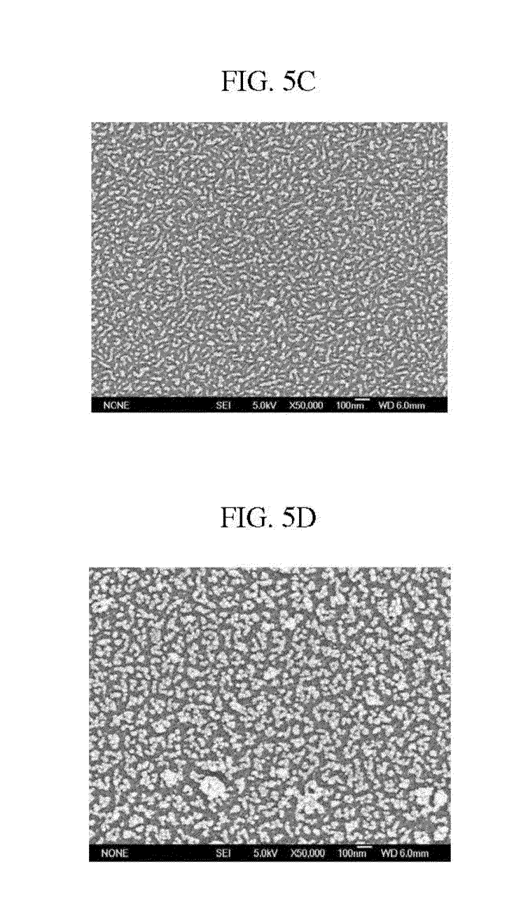

FIGS. 5A through 5D are SEM images of Cu nanoparticles formed on a polyimide substrate, according to an embodiment of the present invention.

Referring to FIGS. 5A through 5D, a substrate including a polymer is a substrate including polyimide, and metal nanoparticles correspond to Cu nanoparticles. In the SEM images, the polyimide substrate corresponds to a dark part and the Cu nanoparticles correspond to a bright part.

It is shown that a size and distribution of the metal nanoparticles on the polymer may be controlled by adjusting a process condition of inductively coupled plasma.

For example, it is shown that gathering of the metal nanoparticles may be controlled according to power applied to maintain the inductively coupled plasma. FIG. 5A shows a case when the power of the inductively coupled plasma is 500 W, and FIG. 5B shows a case when the power of the inductively coupled plasma is 300 W. It is shown that, when the other conditions are the same, if the power of the inductively coupled plasma is increased (from 300 W to 500 W), the metal nanoparticles are better gathered.

As another example, it is shown that gathering of the metal nanoparticles may be controlled according to a process time of the inductively coupled plasma. FIG. 5C shows a case when the process time of the inductively coupled plasma is 30 min., and FIG. 5D shows a case when the process time of the inductively coupled plasma is 10 min. It is shown that, when the other conditions are the same, if the process time of the inductively coupled plasma is reduced (from 30 min. to 10 min.), the metal nanoparticles are better gathered.

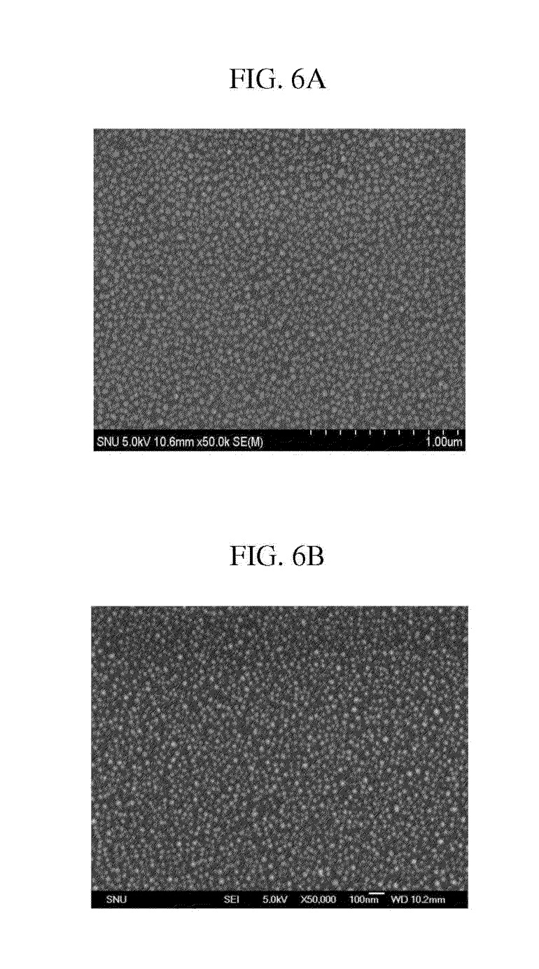

FIGS. 6A and 6B are SEM images of Cu nanoparticles formed on an Si/Si oxide substrate, according to an embodiment of the present invention.

Referring to FIGS. 6A and 6B, a substrate is an Si substrate and may include an Si oxide substrate, and metal nanoparticles correspond to Cu nanoparticles. In the SEM images, the Si substrate corresponds to a dark part and the Cu nanoparticles correspond to a bright part. It is shown that a size of and/or a distance between the metal nanoparticles on the substrate may be controlled by adjusting a process condition of inductively coupled plasma.

For example, it is shown that the size of the metal nanoparticles may be controlled according to a bias voltage applied to the substrate. FIG. 6A shows a case when the bias voltage is 0V, and FIG. 6B shows a case when the bias voltage is −50V. It is shown that, when the other conditions are the same (a process pressure in an inductively coupled plasma device is 20 mT, power of the inductively coupled plasma is 750 W, a process time of the inductively coupled plasma processing is 30 min., and an initial thickness of a Cu thin film on an SiO₂/Si substrate is 4 nm), if the bias voltage is −50V, the size of the metal nanoparticles is reduced.

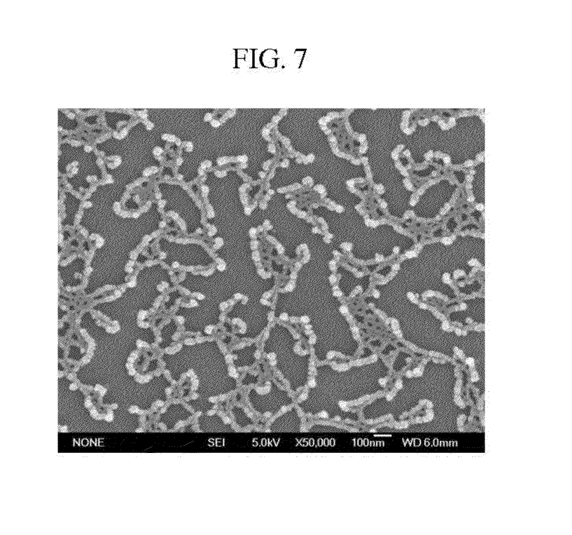

FIG. 7 is an SEM image of Cu nanoparticles formed on a polystyrene substrate, according to an embodiment of the present invention.

Referring to FIG. 7, a substrate including a polymer is a substrate including polystyrene, and metal nanoparticles correspond to Cu nanoparticles. In the SEM images, the polystyrene substrate corresponds to a dark part and the Cu nanoparticles correspond to a bright part.

Hereinabove, a method of forming metal nanoparticles on a substrate, according to an embodiment of the present invention, is described. Effects of the above-described method will now be described.

Initially, an array of uniformly aligned metal nanoparticles may be formed. Since uniform alignment of metal nanoparticles improves characteristics, uniformity of alignment is one of significant conditions in the field of an array of metal nanoparticles. For example, when an absorbance is measured to check plasmon resonance characteristics, if a size of metal nanoparticles, which influences the characteristics, is uniform, a wavelength region of absorbed light is restricted, the amount of absorbed light is increased, and thus such metal nanoparticles may be easily used in the field. Also, for reproducibility of the characteristics, uniformity in size of metal nanoparticles is inevitably required. If the uniformity in size is not achieved, different characteristics occur according to a process time and thus such metal nanoparticles may not be appropriately used in the field. If a metal thin film dewetting process using coprecipitation or heat, which is the most commonly used in industrial fields or laboratories, is used, uniformity of metal nanoparticles is a problem. However, according to an embodiment of the present invention, an array of uniform metal nanoparticles may be formed.

Also, an array of metal nanoparticles capable of adjusting a size of and a distance between the metal nanoparticles may be formed. An array of metal nanoparticles should be formed uniformly and, at the same time, a size of the metal nanoparticles in the array should be adjustable. In the field of an array of metal nanoparticles, characteristics may be adjusted by adjusting the size of the metal nanoparticles. Furthermore, it is appropriate that a range of adjusting the size is large. Although various methods of forming uniform metal nanoparticles by using chemical synthesis are known, their size adjusting ranges are very small from several to several ten nm. If a process capable of increasing a size adjusting range to a level of 100 nm is used, uniformity is greatly reduced. Accordingly, a process capable of maintaining uniformity of metal nanoparticles and increasing a size adjusting range is required. According to an embodiment of the present invention, a size of metal nanoparticles may be adjusted by controlling a thickness of a deposited thin film, and a distance between the metal nanoparticles may be adjusted by using a sputtering effect of plasma. For example, in relation to the sputtering effect of plasma, a size of and/or a distance between the metal nanoparticles may be adjusted by applying a bias voltage onto a substrate and then adjusting the voltage.

Furthermore, a low-temperature process may be enabled. A low process temperature is required in various fields using an array of metal nanoparticles. For example, if an array of gold nanoparticles is used as a catalyst in a process of depositing zinc oxide (ZnO) nanowires on an Si substrate, since the process is generally performed at high temperature, the gold nanoparticles react with the Si substrate to cause contamination of gold due to Si, and characteristics of the ZnO nanowire growing thereon deteriorate. Also, if local plasmon resonance is used in the field of a bio sensor, a flexible substrate material should be used to allow the sensor to be injected into a body. Besides, a flexible substrate is inevitably required in most fields using an array of metal nanoparticles, e.g., a magnetic material or nanowires, in order to expand its region. A flexible substrate material that is usable in consideration of economic feasibility and practicality is a polymer and, in order to use a polymer to form a substrate, a process has to be performed at low temperature to prevent degeneration. A process of forming an array of metal nanoparticles by performing a metal thin film dewetting process using a laser or heat, or a process of forming metal nanoparticles by using chemical synthesis and then bonding it onto a substrate by using heat treatment so as to form an array are not appropriate as a low-temperature process. Inductively coupled plasma used according to an embodiment of the present invention has a representative advantage as a low-temperature process, and the present inventor has successfully deposited a metal thin film on a polymer substrate. Accordingly, according to an embodiment of the present invention, an array of metal nanoparticles may be easily formed by using a low-temperature process.

In addition, an array of metal nanoparticles having a high bonding force to a substrate may be formed. If an array of metal nanoparticles is used in a product, a low bonding force to a substrate causes vulnerability to an external impact and a reduction in lifetime of the product. Accordingly, a high bonding force between the substrate and the array of the metal nanoparticles is inevitably required. In a process of forming and then spraying metal nanoparticles onto a substrate so as to form an array of the metal nanoparticles, in order to improve a bonding force, an additional process is performed. For example, an intermediate layer is deposited or heat treatment is performed. However, according to an embodiment of the present invention, since a target metal thin film is deposited by using sputtering and metal nanoparticles are formed on a substrate and are formed in an array at the same time at low temperature, a high bonding force is maintained without an additional process.

Besides, a short process time may be achieved. A short process time is inevitably required for productivity of an array of metal nanoparticles. In most processes using chemical synthesis, when metal nanoparticles is put on a substrate, in order to increase their uniformity and bonding force, heat treatment is performed at high temperature. In this case, since a process time is about several hours, which is a long time, productivity is reduced. If an array of metal nanoparticles is formed by performing inductively coupled plasma processing, according to an embodiment of the present invention, a process time may be within 30 min. and thus improvement in productivity may be expected.

Moreover, mass production may be allowed. In order to increase productivity, it is inevitable to form a large number of arrays of metal nanoparticles in one process. A process using a laser has an excellent uniformity and a large size adjusting range but may not be easily used in industrial fields due to a very narrow region processible at a time. Also, a process using an aerosol may form metal nanoparticles having an excellent uniformity but may not be appropriate for mass production. However, according to an embodiment of the present invention, inductively coupled plasma processing may be performed on a large area, is currently broadly used for mass production in industrial fields, and thus may be appropriate for mass production.

Additionally, diversity in types of arrays of metal nanoparticles may be ensued. In order to achieve advantages as a method of forming an array of metal nanoparticles, a variety of target metals should be usable. According to an embodiment of the present invention, since a metal thin film is deposited and then processed to form an array of metal nanoparticles, a variety of target metals may be used. For example, the present invention may be applied to Ti, Pt, Co, Fe, Cu, Sn, Ni, Au, and Ag which are broadly used to form metal nanoparticles.

While the present invention has been particularly shown and described with reference to exemplary embodiments thereof, it will be understood by one of ordinary skill in the art that various changes in form and details may be made therein without departing from the spirit and scope of the present invention as defined by the following claims.

1. A method of forming metal nanoparticles on a substrate, comprising:
preparing a substrate comprising a polymer;
forming a metal containing layer on the substrate; and
forming nanoparticles of the metal from the metal containing layer by processing the metal containing layer with inductively coupled plasma.

2. The method of claim 1, wherein the polymer comprises polystyrene.

3. The method of claim 2, wherein the polymer comprises polycarbonate or polyimide.

4. The method of claim 1, wherein the metal comprises copper (Cu), nickel (Ni), silver (Ag), or gold (Au).

5. The method of claim 1, wherein the metal containing layer is formed by using physical vapor deposition (PVD), chemical vapor deposition (CVD), or electrodeposition.

6. The method of claim 1, wherein the inductively coupled plasma is formed by using a discharge gas comprising at least one selected from the group consisting of argon (Ar), hydrogen (H), and helium (He).

7. The method of claim 6, wherein the inductively coupled plasma is formed at a temperature equal to or less than 300° C.

8. The method of claim 1, wherein the forming of the nanoparticles of the metal comprises forming nanoparticles comprising particles having a radius of 10 to 100 nm.

9. The method of claim 1, wherein the forming of the nanoparticles of the metal comprises adjusting a distance between and a size of the nanoparticles of the metal by adjusting a process condition of the inductively coupled plasma applied to the substrate.

10. The method of claim 9, wherein the process condition of the inductively coupled plasma comprises power and a process time of the inductively coupled plasma.

11. The method of claim 9, wherein the process condition of the inductively coupled plasma comprises a bias voltage.

12. The method of claim 1, further comprising oxidizing or nitrifying the formed nanoparticles of the metal.

13. The method of claim 1, wherein the forming of the nanoparticles of the metal comprises performing a dewetting process by processing the metal containing layer with the inductively coupled plasma.

14. A method of forming metal nanoparticles on a substrate, comprising:
preparing a substrate;
forming a metal containing layer on the substrate; and
forming nanoparticles of the metal from the metal containing layer by processing the metal containing layer with inductively coupled plasma by applying a bias voltage.

15. The method of claim 13, wherein the inductively coupled plasma is formed by using a discharge gas comprising at least one selected from the group consisting of argon (Ar), hydrogen (H), and helium (He).

16. The method of claim 13, wherein the forming of the nanoparticles of the metal comprises adjusting a distance between and a size of the nanoparticles of the metal by adjusting a process condition of the inductively coupled plasma applied to the substrate.

17. The method of claim 16, wherein the process condition of the inductively coupled plasma comprises power and a process time of the inductively coupled plasma, and a condition for applying the bias voltage.

18. The method of claim 13, further comprising oxidizing or nitrifying the formed nanoparticles of the metal.

19. Metal nanoparticles on a substrate, comprising:
a substrate comprising a polymer; and
nanoparticles of metal directly contacting and distributed on the substrate.

20. The metal nanoparticles of claim 19, wherein the metal comprises copper (Cu), nickel (Ni), silver (Ag), or gold (Au).
